(19) United States
(12) Patent Application Publication
(10) Pub. No.: US 2011/0270841 A1
(43) Pub. Date: Nov. 3, 2011

(54) Distributed Tag-Based Correlation Engine

(75) Inventors: Manish Bhardwaj, San Jose, CA (US); Jining Tian, Cupertino, CA (US); Gursharan Singh, San Jose, CA (US)

(73) Assignee: Cisco Technology, Inc., San Jose, CA (US)

(21) Appl. No.: 12/769,217

(22) Filed: Apr. 28, 2010

(51) Int. Cl. G06F 17/30

(52) U.S. Cl. 707/741; 707/E17.002

(57) ABSTRACT

Systems may use explicit ratings from users to construct user to user correlations. This technique may reduce the user-content correlation to a single dimension, i.e., the content that a plurality of users may rate similarly. Embodiments of the present invention may use DHT as an underlying distributed signaling mechanism, but may also make the rating implicit. Furthermore, embodiments of the present invention may construct the user to content correlation based on multi-dimensional metadata related to the content.

### FIELD OF THE DISCLOSURE

The present disclosure relates to a distributed tag-based correlation engine, and more specifically creating a collaborative content recommendation system.

### BACKGROUND

Socially collaborative filtering has emerged as one of the most popular techniques in recommendation systems. It has become part of almost all commercially deployed recommendation systems including various online retailers. With the explosion of content and the ever growing need to provide more relevant recommendations to the user, efficient and more fine grained recommendation systems are needed. The current limitations of centralized correlation engines have hampered the number of dimensions over which correlations can be performed. There is a need for an efficient distributed correlation engine which may utilize Distributed Hash Tables (“DHT”) to create a multi-dimensional correlation rating based on a consumer's interaction with the content instead of explicit polling.

### BRIEF DESCRIPTION OF THE DRAWINGS

The accompanying drawings, which are incorporated herein constitute a part of this disclosure, illustrate various embodiments of the present invention. In the drawings:

FIG. 1 illustrates operating embodiments of the present invention.

FIG. 2 illustrates embodiments of the present invention.

FIG. 3 illustrates a flow chart of embodiments of the present invention.

Both the foregoing general description and the following detailed description provide examples and are explanatory only. Accordingly, the foregoing general description and the followed detailed description should not be considered to be restrictive. Further, features or variations may be provided in addition to those set forth herein. For example, embodiments may be directed to various feature combinations and sub-combinations described in the detailed description.

### DETAILED DESCRIPTION

The following detailed description refers to the accompanying drawings. Wherever possible, the same reference numbers are used in the drawings and the following description to refer to the same or similar elements. While embodiments may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Systems may use explicit ratings from users to construct user to user correlations. This technique may reduce the user-content correlation to a single dimension, i.e., the content that a plurality of users may rate similarly. Embodiments of the present invention may use a DHT as an underlying distributed signaling mechanism, but may also make the rating implicit. Furthermore, embodiments of the present invention may construct the user to content correlation based on multi-dimensional metadata related to the content.

While embodiments may be described in a DHT environment, it should be understood that embodiments of the invention relate generally to the construction of overlays.

When providing an overlay, DHTs may be used to provide a structured overlay construction. Each DHT ring may operate as an autonomous content indexing and delivery systems via basic PUT/GET operations. The DHT may store content via a PUT(key, value) operation. The DHT may then retrieve the value by a GET(key) operation. The value may be a descriptor that contains locations where the content is stored. The locations where the content is stored may be referred to as resources.

Content may be indexed by hashing an extensible resource identifier (“xri”) of the content to generate a key. The content may be stored via a PUT operation employing the key and the descriptor value. The content may then later be located by hashing the xri and subsequently performing a GET operation on the generated key to retrieve the descriptor. The content may then be downloaded from the resources listed in the descriptor.

In addition to the location of the content, each content descriptor also may contain metadata in the form of tags. Such tags may be searchable attributes which describe the content. In the case of a movie, for example, attributes may include actor, language, and/or genre. In some embodiments, tags may be created by a content provider based on the content provider's assessment of popular and relatable attributes of the content. In some embodiments, the tags may be created by users of a content rating system.

Regardless of the source, the tags may be organized into tagsets. Tagsets may comprise weighted ordered lists of tags. The tagsets may have a 1:1 relationship with correlated usersets. Thus, at any given time, the number of tagsets should be equal to the number of usersets. Furthermore, the tagsets may be dynamic entities which may be updated in real-time or periodically as the tagsets are updated to reflect changes in user interests as described below.

In some embodiments, the tags may be weighted based on the number of times a user has viewed content that contains the tags. Furthermore, the age of last update to the tagset may be further taken into account. A system operator may establish a threshold level at which a tag may be replaced.

Each tagset may have an associated xri. In some embodiments, the xri of a tagset will comprise a string of the concatenated alphabetically-ordered list of tags contained in the tagset. For example, a tagset created by users interested in action movies starring Bruce Willis in English may be xri://action.english.willis. By hashing this xri, a user can generate the key which may be used to get the descriptor value containing the locations where the related content is stored.

The tagset descriptor value may also contain the list of users subscribed to the tagset. In other words, the tagset descriptor value may also contain the list of users in the associated userset. In some embodiments, the tagset descriptor value may further include content to recommend to users subscribed to the tagset. In some embodiments, the tagset may be generated based on the content the userset subscribed to the tagset have viewed. In some embodiments, the system may maintain a user descriptor used for user management. The user descriptor may contain the xri associated with the tagset which the user is interested in.

When a user interacts with content, a DHT node that may be acting as the content server may use implicit rating algorithms to determine the level of interest that a user has to the content. The DHT node may have already performed a GET operation on the user descriptor for billing purposes. Likewise, the DHT node may have performed a GET operation on the content descriptor to determine the locations where to download the content from upon request by the user.

If the DHT node may determine that a user is interested in the presented content, the DHT node may perform a GET operation on the tag-set descriptor associated with the user. Thus, the DHT node may have access to the list of tags the user was interested into prior to this most recent content interaction. The content server may update the list of user tags based on a configurable updating algorithm. The content server may then create a new tagset for the user if the new tagset differs from the previously obtained tagset for the user.

To update a tagset, the DHT node may first send an unsubscribe message to the previously obtained tagset. A subscribe message may then be sent to the new tagset. This subscribe message may be sent regardless of whether the previously obtained tagset has been updated. The unsubscribe message may contain a user identification. The subscribe message may contain a user identification and the content identification which has necessitated the updated tagset.

Tagsets may be classified as regular tagsets and super tagsets. A regular tagset may be a tagset that does not have a large enough set of users to be able to generate sufficient recommendations. Such regular tagsets may be subscribed to one or more super tagsets. These super tagsets may have large usersets sufficient to make recommendations. A regular tagset may thus receive recommendation information from its subscribed-to super tagset.

In some embodiments, all super tagsets may be registered in a central location. For example, the central location may be a content-ingest server located on the network. New content may be advertised to the super tagsets, which may in turn advertise the new content to users subscribed to the subscribing regular tagsets. In some embodiments, the content-ingest server may choose to advertise to subsets of super tagsets that have been determined to be more correlated to the new content.

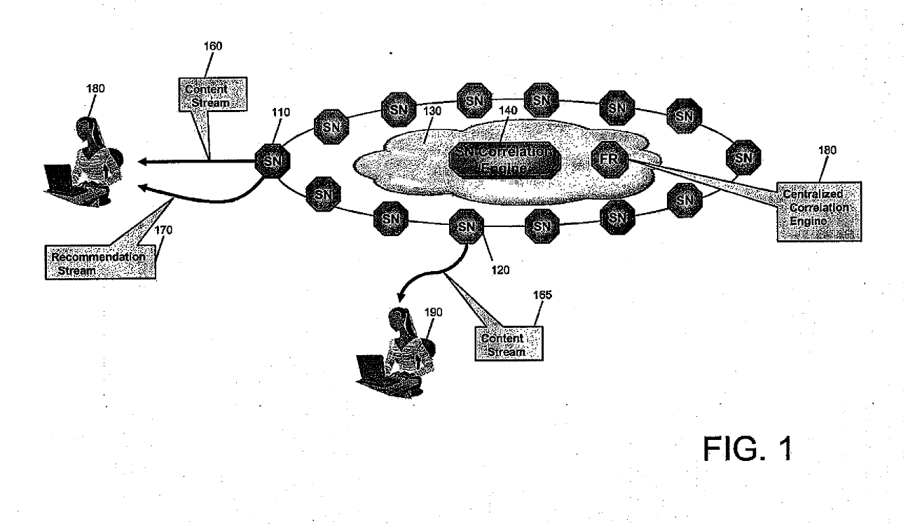

FIG. 1 illustrates operating embodiments of the present invention. A plurality of service nodes may exist across a network, such as network 140. Each service node may provide access to content residing in various locations across network 140. For example, user 180 may be accessing network 140 through a DHT service node 110. Similarly, user 190 may be accessing network 140 through service node 110.

User 180 may request content from service node 110. The requested content may be delivered across content stream 160. Similarly, user 190 may receive requested content across content stream 165. When user 190 interacts with content, service node 120 may use implicit rating algorithms to determine the level of interest that user 190 has to the requested content.

If service node 120 may determine that user 190 is interested in the presented content, the tag-set descriptor associated with user 190 may be obtained. The content server may update the list of user tags based on a configurable updating algorithm. A new tagset may then be updated for user 190 if the new tagset differs from the previously obtained tagset.

In some embodiments, a service node correlation engine 140 may operate to correlate data and present recommendations to a user. For example, interest expressed by user 190 towards particular content, may be data which in considered by correlation engine 140. Correlation engine 140 may operate to provide recommendations to user 180 through recommendation stream 170.

In some embodiments, service node 120 may be operating from a cold start and presents content that is new and has not been rated by any user. A centralized correlation engine 180 may be employed to correlate the new content with existing content. Then, the new content may be recommended to users correlated to the related existing content.

Centralized correlation engine 180 may operate to pre-position existing tagset keys and tagset membership. When a new tagset is created or destroyed the centralized correlation engine 180 will update its database. Such updates are expected to be infrequent during non-transient operation.

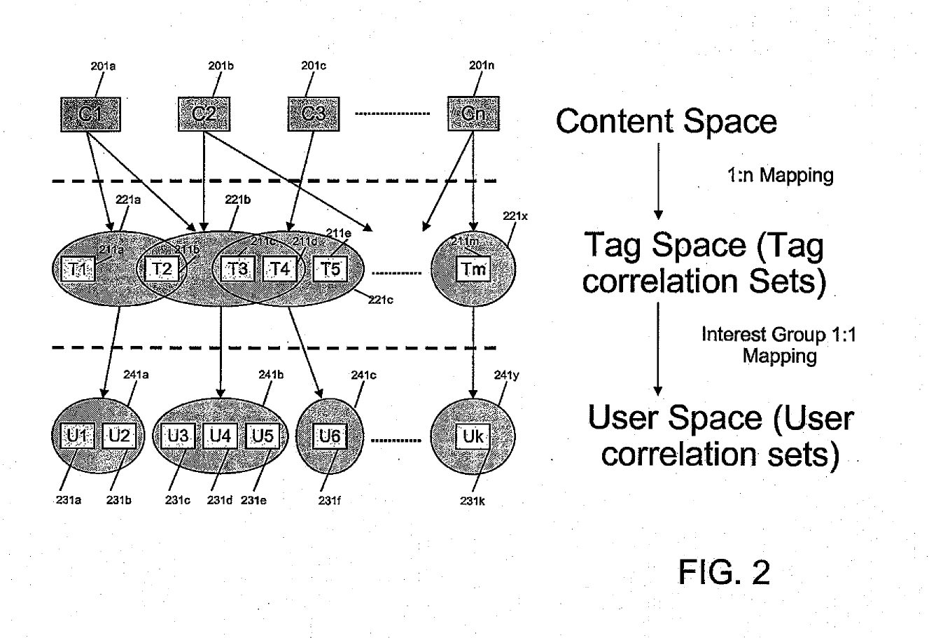

FIG. 2 illustrates embodiments of the present invention. A plurality of content spaces may exist containing content. For example, content spaces 201a, 201b, 201c . . . 201n may each represent individual content spaces. The number of content spaces is not meant to be restricted by this illustration. The content spaces 201a . . . 201n map to a plurality of tag spaces in a 1:n ratio. In other words, each content space may map to one or more tag spaces.

Tag spaces may be for example, tag space 211a, 211, 211, 211d, 211e . . . 211m. Tag spaces may be grouped into tag correlation sets, such as 221a, 221b, 221c . . . 221x. As can be seen, a tag space may exist in multiple tag correlation sets. For example, tag space 211b is contained within both tag correlation set 221a and tag correlation set 221b.

Each tag correlation set may be related to a user correlation set. For example, user spaces 231a, 231b, 231c, 231d, 231e, 231f . . . 231k each belong to a single user correlation set, such as user correlation sets 241a, 241b, 241c . . . 241y. The relationships illustrated in FIG. 2 show that embodiments of the present invention may reduce the total number of entries in the DHT over a traditional distributed collaborative filtering approach which may simply match each content space directly to a user space.

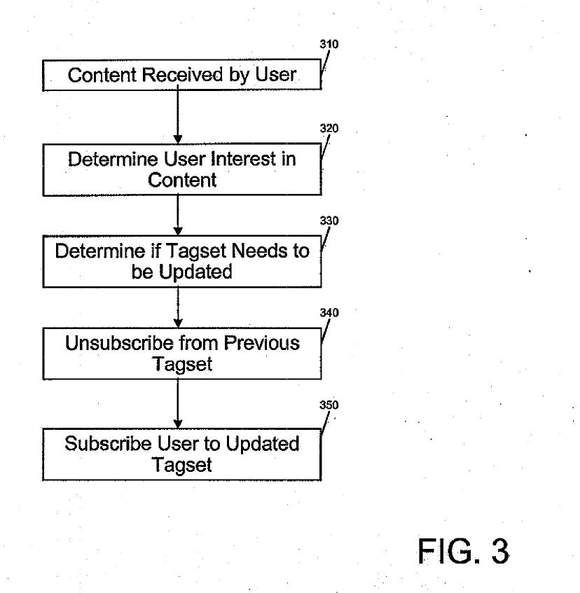

FIG. 3 illustrates a flow chart showing operation of embodiments of the present invention. The method may commence at step 310 where content may be requested by a user and subsequently received by the user. The content may be provided by a content server. In some embodiments, the content server may be a DHT node.

The method may then proceed to step 320 where the user's interest in the received content may be determined. The algorithms used to determine interest may not be limited by this disclosure, but should be sufficient to determine a level of interest or lack thereof by the user. Once the user's interest in the content is determined, the method may proceed to step 330.

At step 330, the method may determine if a tagset associated with the user needs to be updated based on the received content and the determined level of interest. If the tagset needs to be updated, the method may proceed to step 340 where the user may be unsubscribed from their previously subscribed to tagset.

Once the unsubscribe process is completed at step 340, the method may proceed to step 350 where the user is subscribed to the updated tagset. The subscription request may include a user identification value and a tagset identification value.

In some embodiments, a server may operate as the root of the tagset. For example, a server may own the key-space which includes the tagset key. Thus, when the server receives an unsubscribe message, the server may remove the user from the list of users in the tagset descriptor.

When a DHT node receives a subscribe message, the DHT node may create the tagset descriptor if the tagset did not previously exist. Furthermore, the DHT node may add the user to a list of users in the tag-set descriptor. Also, in some embodiments, the DHT node may add the content to the list of content that the userset subscribed to the tagset find interesting. In some embodiments, the content that is listed in the tagset descriptor may be essentially that which the userset has filtered collaboratively and can be recommended to all users subscribed to the tagset.

Embodiments of the present invention may be embodied in any computer-readable medium for use by or in connection with an instruction execution system, apparatus, or device. Such instruction execution systems may include any computer-based system, processor-containing system, or other system that can fetch and execute the instructions from the instruction execution system. In the context of this disclosure, a “computer-readable medium” can be any means that can contain, store, communicate, propagate, or transport the program for use by, or in connection with, the instruction execution system. The computer readable medium can be, for example but not limited to, a system or that is based on electronic, magnetic, optical, electromagnetic, infrared, or semiconductor technology.

Specific examples of a computer-readable medium using electronic technology would include (but are not limited to) the following: random access memory (RAM); read-only memory (ROM); and erasable programmable read-only memory (EPROM or Flash memory). A specific example using magnetic technology includes (but is not limited to) a portable computer diskette. Specific examples using optical technology include (but are not limited to) compact disk (CD) and digital video disk (DVD).

Any software components illustrated herein are abstractions chosen to illustrate how functionality may be partitioned among components in some embodiments of the present invention disclosed herein. Other divisions of functionality may also be possible, and these other possibilities may be intended to be within the scope of this disclosure. Furthermore, to the extent that software components may be described in terms of specific data structures (e.g., arrays, lists, flags, pointers, collections, etc.), other data structures providing similar functionality can be used instead.

Any software components included herein are described in terms of code and data, rather than with reference to a particular hardware device executing that code. Furthermore, to the extent that system and methods are described in object-oriented terms, there is no requirement that the systems and methods be implemented in an object-oriented language. Rather, the systems and methods can be implemented in any programming language, and executed on any hardware platform.

Any software components referred to herein include executable code that is packaged, for example, as a standalone executable file, a library, a shared library, a loadable module, a driver, or an assembly, as well as interpreted code that is packaged, for example, as a class. In general, the components used by the systems and methods of reducing media stream delay are described herein in terms of code and data, rather than with reference to a particular hardware device executing that code. Furthermore, the systems and methods can be implemented in any programming language, and executed on any hardware platform.

The flow charts, messaging diagrams, state diagrams, and/or data flow diagrams herein provide examples of the operation of systems and methods of reducing media stream delay through independent decoder clocks, according to embodiments disclosed herein. Alternatively, these diagrams may be viewed as depicting actions of an example of a method. Blocks in these diagrams represent procedures, functions, modules, or portions of code which include one or more executable instructions for implementing logical functions or steps in the process.

Alternate implementations may also be included within the scope of the disclosure. In these alternate implementations, functions may be executed out of order from that shown or discussed, including substantially concurrently or in reverse order, depending on the functionality involved. The foregoing description has been presented for purposes of illustration and description. It is not intended to be exhaustive or to limit the disclosure to the precise forms disclosed. Obvious modifications or variations are possible in light of the above teachings. The implementations discussed, however, were chosen and described to illustrate the principles of the disclosure and its practical application to thereby enable one of ordinary skill in the art to utilize the disclosure in various implementations and with various modifications as are suited to the particular use contemplated. All such modifications and variation are within the scope of the disclosure as determined by the appended claims when interpreted in accordance with the breadth to which they are fairly and legally entitled.

What is claimed is:

1. A content indexing system comprising:
a plurality of tagsets comprises of one or more tags, wherein each tag represents a searchable attribute of a piece of content, wherein each tagset may be subscribed to by a plurality of users;
a plurality of usersets wherein each userset correlates to one of the plurality of tagsets;
a correlation engine;
a plurality of extensible resource identifiers, wherein each extensible resource identifier is associated with a piece of content;
a plurality of keys, wherein each key is generated by hashing the associated extensible resource identifier; and
a plurality of descriptor values, wherein each descriptor value comprises locations at which the associated piece of content may be located and wherein each descriptor value may be located by use of the associated key.

2. The content indexing system of claim 1, wherein the searchable attribute of a piece of content is one of actor, language, or genre.

3. The context indexing system of claim 2, wherein the searchable attribute is stored as metadata.

4. The context indexing system of claim 3, wherein the searchable attribute is created by a content provider.

5. The context indexing system of claim 1, wherein the tagsets are updated dynamically.

6. The context indexing system of claim 1, further comprising a user descriptor associated with each user which contains the extensible resource identifiers for the tagsets associated with the users.

7. The context indexing system of claim 1, wherein each extensible resource identifier comprises an alphabetic, concatenated list of tags in a related tagset.

8. The context indexing system of claim 1, wherein the correlation engine operates to correlate related users with common interests in content.

9. The context indexing system of claim 1, further comprising super tagsets comprised of a plurality of tagsets.

10. A method comprising:
receiving content from a content server;
determining interest of the user in the received content;
determining if a tagset associated with the user needs to be updated based on the received content;
unsubscribing the user from a previously subscribed to tagset; and
subscribing the user to the updated tagset.

11. The method of claim 10, wherein the content server is a DHT node.

12. The method of claim 10, further comprising: correlating a userset to the updated tagset.

13. The method of claim 10, wherein the step of subscribing further comprises transmitting a user identification value and a tagset identification value.

14. The method of claim 13, further comprising: determining whether the requested tagset exists and creating the tagset.

15. The method of claim 14, further comprising:
creating a super tagset containing a subset of the plurality of tagsets; and
registering the super tagset at a central location.

16. A content indexing system comprising:
a plurality of content spaces containing content;
a plurality of tag spaces, wherein the plurality of content spaces map to the plurality of tag spaces in a 1:n ratio;
a plurality of tag correlation sets, each containing a subset of the plurality of tag spaces;
a plurality of user correlation sets, comprising a plurality of user space, wherein the plurality of user correlation sets map to the plurality of tag correlation sets in a 1:1 ratio.

17. The content indexing system of claim 16, wherein an individual tag space exists in multiple tag correlation sets.

18. The content indexing system of claim 17, further comprising:
a server operating as the root of the tagset.

19. The content indexing system of claim 18, wherein the server own a key-space which includes the tagset key.

20. The content indexing system of claim 19, wherein the server handles subscribe and unsubscribe requests.
